(19) United States
(12) Patent Application Publication
(10) Pub. No.: US 2008/0243845 A1
(43) Pub. Date: Oct. 2, 2008

(54) SERVER ASSIGNMENT BASED ON TRENDS IN USERNAME CHOICES

(76) Inventors: Rita H Wouhaybi, Hillsboro, OR (US); Mic Bowman, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/692,427

(22) Filed: Mar. 28, 2007

(51) Int. Cl. G06F 17/30

(52) U.S. Cl. 707/7

(57) ABSTRACT

A method and computer readable medium are disclosed. In one embodiment, the method includes sorting users into groups, where each group includes all usernames that have a same prefix string, calculating a usage factor for each user group, reserving a portion of total server storage space for each user group proportional to the usage factor for each user group, and storing the user data in each user group in the reserved storage space for each user group based on the username choices.

### FIELD OF THE INVENTION

The invention relates to server assignments. More specifically, the invention relates assigning users in a service to servers based on username choices.

### BACKGROUND OF THE INVENTION

Networks that require username authentication have proliferated throughout the world as personal computers and computer networks have become commonplace. Subscribers to these networks and services have to choose a username to represent their identity. Since these networks and services are distributed among several servers, sometimes even in different geographical locations, a decision has to be made on where to store the data of every user and how to replicate this data if fault tolerance is a requirement. In order to solve this problem, different solutions have been utilized and many require a group of storage servers to store the database of username files and a front end locator server which has specific locations of all the users data. There are many complex applications that perform these types of operations, one common example is Microsoft® Active Directory. The goal of these applications is to attempt to achieve fair user to server assignments and load balancing.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of a username storage system to assign servers based on username choices.

FIG. 2 is a flow diagram of one embodiment of a process to assign servers for username storage based on username choices.

FIG. 3 is a flow diagram of one embodiment of a process to assign a new username to a location in a username database on a username storage server based on username choices.

### DETAILED DESCRIPTION OF THE INVENTION

Embodiments of a method and computer readable medium to assign servers for user data storage based on username choices are described. In the following description, numerous specific details are set forth. Additionally, well-known elements, specifications, and protocols have not been discussed in detail in order to avoid obscuring the present invention.

References to “one embodiment”, “an embodiment”, “example embodiment”, “various embodiments”, “some embodiments”, “many embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled”, along with its derivatives, may be used. In particular embodiments, “coupled” is used to indicate that two or more elements co-operate or interact with each other, but they may or may not be in direct physical or electrical contact.

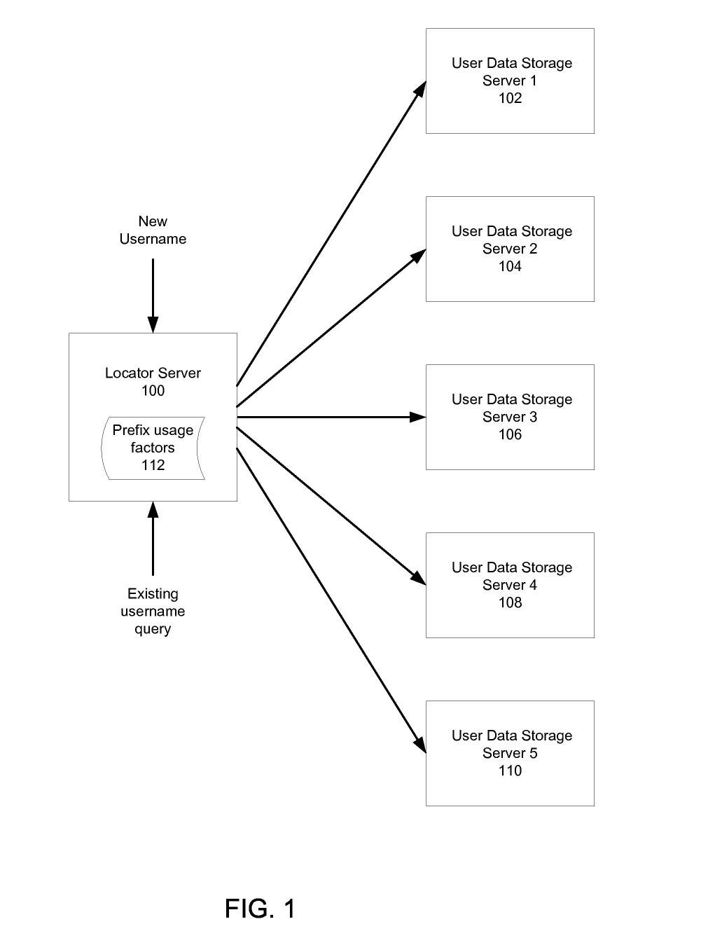

FIG. 1 describes one embodiment of a user data storage system to assign servers based on username choices. In different embodiments, locator server 100 may be any type of computer system that has adequate storage and computing power to receive a new user or a request for a current user, and point the request to the correct storage location. In many embodiments, the locator server can be part of the physical storage server or a separate entity.

In many embodiments, the locator server 100 is coupled to one or more user data storage servers. In the illustrated embodiment there are five user data storage servers (102, 104, 106, 108, and 110 respectively). The group of user data storage servers store the data for the users among them. In some embodiments, the entire set of usernames are referred to as a username database. Each user data storage server is a computer system with significant non-volatile storage. In some embodiments, each user data storage server has a RAID hard drive storage system.

Each username stored in the database of user data is a string of characters. In some embodiments, username naming rules may limit the possibilities for valid usernames. For example, in some embodiments, the naming rules for a username may include only allowing alphanumeric characters (A-Z, a-z, 0-9). Other embodiments can allow for the use of special characters such as the underscore (_). Additionally, in many embodiments, an additional naming rule for a username may include only allowing usernames that are greater than or equal to a certain number of characters (e.g. the username must be at least 8 characters in length). Though, in other embodiments, there are no limitations to username naming rules.

The locator server 100 stores information to assist in routing incoming new user or existing user data storage or retrieval requests to the correct user data storage server for storing or reading/modifying the user data respectively. The stored information on the locator server 100 includes a list of character strings of a certain length. In most embodiments, the length of the character strings stored on the locator server are significantly shorter in length than the minimum character length for a valid username.

In some embodiments, the locator server 100 stores individual alphanumeric character prefix strings of a length of one character. For example, in some of these embodiments, there would be a total of 36 prefix strings that comprise the all of the letters a-z (26 strings), and the numbers 0-9 (10 strings). This information of 36 strings can be capable of grouping usernames. For each username where the naming convention is limited to these 36 individual alphanumeric characters, the first character in the username string will be one of the 36 stored prefix strings. As usernames are sorted, every username will fall into one of these 36 groups corresponding to one of the 36 prefix strings. In other embodiments, character strings of greater than a length of one may be used for sorting usernames into groups. In other embodiments, the character strings of one or more characters do not necessarily need to start with the first character in the username, though starting with the first character is the most common sorting mechanism. In many embodiments, the locator server 100 also stores a count of usernames that fall into each group.

Once all usernames in the username database are sorted into a group, the locator server will have a usage factor per group. In some embodiments, the usage factor for any given group is proportional to the number of usernames in that group divided by the total number of usernames in the database. In many embodiments, prefix string usage factor information 112 is stored on locator server 100. In any username database, it is noteworthy that certain groups will have a higher usage factor than other groups. For example, returning to the 36 group example, it is quite likely that for any set of users, there will be more people that begin their usernames with the letter “s” than the letter “q”. Thus, the group that includes all usernames starting with the letter “s” will have a higher usage factor than the group that includes all usernames starting with the letter “q”.

In many embodiments, the locator server 100 can additionally store pointers and storage address ranges to all storage locations within the entire set of user data storage servers. Thus, for each user group, the locator server 100 can assign a portion of the total storage space among all user data storage servers close to or equal to the usage factor for that group. For example, if the user group “s” has a usage factor of 5% and the user group “q” has a usage factor of 0.25%, the locator server 100 may assign 5% of the total storage space among all user data storage servers to group “s” and may assign 0.25% of the total storage space among all usemame storage servers to group “q”.

Therefore, in many embodiments, the locator server 100 stores at least three types of information: the set of character string groups, the count of usernames within each character string group, and the storage locations reserved for each prefix string group.

In other embodiments, there may be more than one locator server. In some embodiments, there may be multiple levels of locator servers, wherein the first level of locator server directs the new user information or query to a second set of more specific locator servers. In these embodiments, a first locator server will sort user data files based on the first character of usernames and route the queries to a second group of additional locator servers to sort user data files based on subsequent characters after the first character in each username. For example, if the first locator server is sorting user files based on the first character in a prefix string (e.g. “a” through “z”), a second group of locator servers may sort user files into specific storage servers reserved for storing portions of each first character prefix string group (e.g. “aa” through “ad” on one storage server, “ae” through “ah” on another storage server, and so on). In some embodiments, certain more common first characters in prefix strings may require additional distribution (e.g. “sa” through “sc” on one storage server, “sd” through “sf” on another storage server, and so on), whereas other less common first characters in prefix strings may require less distribution or no cross server distribution at all (e.g. all of “q” resides on a single storage server).

Usage factors per group may vary over time. Thus, for any user locator service, it may become necessary to redistribute the reserved storage space for one or more character prefix groups from time to time. When the groups are first sorted, the amount of total storage space among all user data storage servers that is reserved for each group will be proportional to each group's usage factor. As new usernames enter into the username database (as well as when current usernames are deleted) the group usage factor per group may increase or decrease in proportion to the percentage of total reserved storage space.

In some embodiments, if a given group's usage factor increases or decreases in proportion to the percentage of total reserved storage space, that group's total reserved storage space may be redistributed to account for this change. For example, if the “q” group has a total reserved storage space amount of 0.25% and over the course of time the “q” group's usage increases to 0.85%, the percentage difference would be 0.6%. The percentage difference may result in a redistribution of the “q” group storage server allocation depending on the set of criteria for redistribution as defined by the service owner. In other words, if the “q” group is assigned to a specific storage server, the 0.6% increase in the “q” group's usage may overflow the storage ability of the allocated storage server. Thus, in this case it would become imperative for some or all of the user data, corresponding to the “q” usernames, stored on the server to be redistributed to one or more other servers.

In some embodiments, criteria are put on place by the service owner. In one embodiment, a specific criterion may be a certain amount of change in a group's usage factor in comparison to the original total reserved storage space allocation. If the actual change matches one criterion or more for a given group, it triggers a redistribution of a subset of the groups allocated storage space.

In some embodiments, once one group's usage factor changes to the extent that it triggers a change, the locator server 100 redistributes the storage space for all groups to match the current usage factors. In other embodiments, only a fraction of the total number of groups participate in any one reserved storage space redistribution. In some embodiments, there is a set of criteria utilized to determine when a redistribution is required of storage server allocation per prefix string. In different embodiments, these criteria may include one or more usage factors changing significantly enough in relationship to each of their corresponding reserved total storage portions.

In some embodiments, one or more additional servers are brought online when one group meets its criteria for redistribution (i.e. redistribution criteria). In these embodiments, when a group meets its redistribution criteria, the group is allocated new storage space on one or more new storage servers. Thus, only the group meeting its redistribution criteria would require redistribution of its allocated storage space.

In some embodiments, the string prefix utilized may change in length to facilitate redistributing a portion of a group to another server. Thus, if the server allocated to store user data corresponding to usernames beginning with “q” is full, the “q” group may be split into two or more groups and using a partial redistribution process. The original server that was allocated to store the entire “q” group may now only store the “qa” through “qm” portion of the “q” group, and a newly allocated server may now store the “qn” through “qz” portion of the “q” group.

In some embodiments, redistribution may occur by allocating another locator server at a 2nd tier of locator servers (a tiered embodiment of locator servers is discussed in greater detail above). A 2nd tier locator server may be brought online to locate user data locations in a limited range utilizing longer prefix strings.

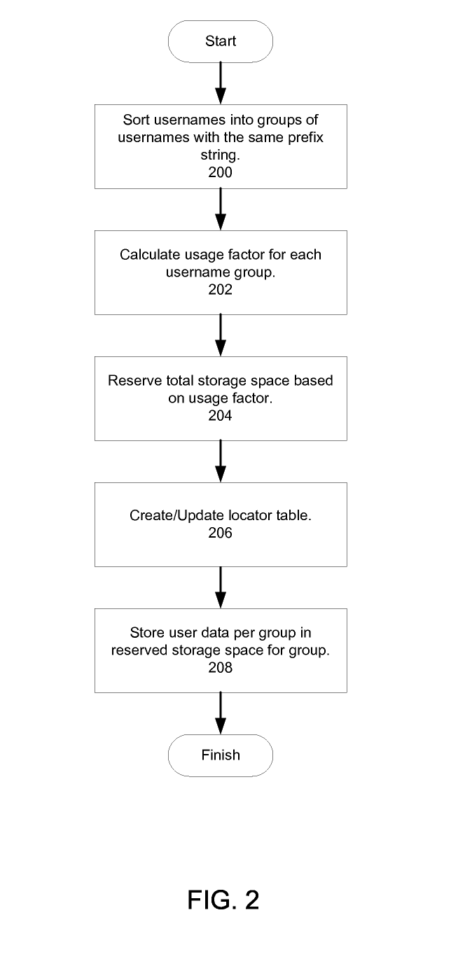

FIG. 2 is a flow diagram of one embodiment of a process to assign servers for user data file storage based on username choices. The process is performed by processing logic that may comprise hardware (circuitry, dedicated logic, etc.), software (such as is run on a general purpose computer system or a dedicated machine), or a combination of both. Referring to FIG. 2, the process begins by processing logic sorting usernames corresponding to user data files into groups of usernames with the same prefix string (processing block 200). The prefix string is a string of a certain length that starts with the first character of the username. Thus, if the string is one in length “samantha,” “stephen,” and “sarah” would all be in the same group, but “william” and “1smith” would each be in groups different from each other as well as different from the “s” group including the first three usernames. Again, even though the groups are referred to as username groups, the groups actually consist of user data files, wherein the username field within the user data file is the key to sorting and storing the file into a common group. In many embodiments, prefix strings in one locator may have different lengths. For example, the prefix string of one group may be the letter “q” while another is “se”.

Next, processing logic calculates the usage factor for each username group (processing block 202). The usage factor for any given group can be proportional to the number of usernames in that group divided by the total number of usernames in the database. Then, processing logic reserves a portion of the total storage space for each group that is equivalent to the usage factor for that group (processing block 204). In some embodiments, the reserved storage space for a group is a contiguous logical space within the total storage space that is represented by an address range of storage locations.

Then, processing logic will create or update a locator table within one or more locator servers that correspond to the locations of each storage server or servers storing each separate prefix string. If this process is for the initial population of storage servers, then the table would need to be created. If this process is for a redistribution of storage space for one or more character prefix strings, then the table would only need to be updated to reflect the current allocation of storage space locations per prefix string.

Finally, processing logic stores the user data per group in the reserved storage space for the group (processing block 206) and the process is finished. In some embodiments, this processing block may refer to the initial construction of the username database, though, in other embodiments this processing block is not necessary for all user data if there is a partial redistribution of some, but not all of the user data files.

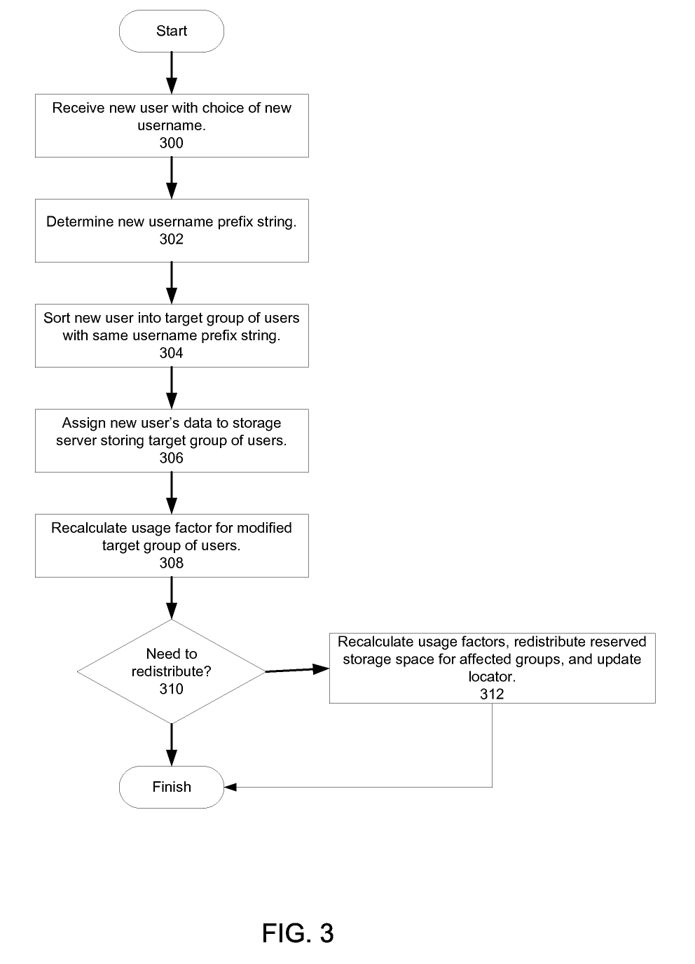

FIG. 3 is a flow diagram of one embodiment of a process to assign a new user to a location in a user data storage server based on username choices. The process is performed by processing logic that may comprise hardware (circuitry, dedicated logic, etc.), software (such as is run on a general purpose computer system or a dedicated machine), or a combination of both. Referring to FIG. 3, the process begins by processing logic receiving a new user with the user's choice of a new username (processing block 300). The process continues with processing logic determining the new username prefix string (processing block 302). In many embodiments, processing logic is aware of the length of the prefix strings utilized for determining storage locations. For example, in some embodiments, the prefix string is one character in length. Thus, processing logic would parse the first character in the username to obtain the string.

Next, processing logic sorts the new user into a target group of users whose usernames all begin with the same prefix string (processing block 304). For example, if the username is “theodore” the user would be sorted into the “t” group of users. Then processing logic assigns the new user's data to a storage server storing at least a portion of the target group of users (processing block 306). Thus, for example, if there are five user data storage servers and storage server #4 stores the entire group of users with usernames start with “t”, processing logic assigns the new user's data to a storage location in server #4.

Then processing logic recalculates the usage factor for the target group that increased with the addition of the new users (processing block 308).

Next, processing logic determines a redistribution is required (processing block 310). In some embodiments, if the target group has a usage factor that exceeds its total reserved storage space, then a redistribution would need to occur for that group. In some embodiments, the target group is the only group requiring redistribution of allocated storage space. In other embodiments, one or more additional groups may require redistribution.

If the target group does not require redistribution then the process is finished. If the target group does require redistribution, then processing logic recalculates the usage factors and redistributes reserved storage space for all affected groups (processing block 312) and the process is finished.

Thus, embodiments of a method and computer readable medium to assign servers for user storage based on username choices are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
sorting a plurality of usernames into a plurality of groups, each group comprising all usernames from the plurality of usernames that have a same prefix string of a length;
calculating a usage factor for each group;
reserving a portion of a total storage space among a plurality of storage servers for each group, wherein the total storage space for each group is proportional to the usage factor for each group; and
storing user data for each group in the reserved storage space for each group.

2. The method of claim 1, further comprising:
receiving a new user, wherein the user has a new username;
determining the new username prefix string;
sorting the new user into a target group of users, wherein all users in the target group of users have usernames with the same prefix string of the new username;
assigning data associated with the new user to be stored on a target storage server storing at least a portion of the target group of users; and
recalculating the usage factor for at least one user group.

3. The method of claim 2, further comprising:
determining whether at least one of the one or more recalculated usage factors has exceeded at least one of the corresponding one or more total reserved storage space portions;
redistributing the reserved storage space for one or more user groups each with usage factors exceeding the corresponding one or more total reserved storage space portions.

4. The method of claim 3, wherein redistributing the reserved storage space further comprises increasing the prefix string length by one or more characters and redistributing a first user group into two or more new user groups, wherein each of the two or more new user groups is a subset of the first user group.

5. The method of claim 1, wherein a given storage server stores at least all users with usernames beginning with a given prefix string.

6. A computer readable medium having embodied thereon instructions, which when executed by a computer, causes the computer to perform a method, comprising:
sorting a plurality of usernames into a plurality of groups, each group comprising all usernames from the plurality of usernames that have a same prefix string of a length;
calculating a usage factor for each group;
reserving a portion of a total storage space among a plurality of storage servers for each group, wherein the total storage space for each group is proportional to the usage factor for each group; and
storing user data for each group in the reserved storage space for each group.

7. The computer readable medium of claim 6, further comprising:
receiving a new user, wherein the user has a new username;
determining the new username prefix string;
sorting the new user into a target group of users, wherein all users in the target group of users have usernames with the same prefix string of the new username;
assigning data associated with the new user to be stored on a target storage server storing at least a portion of the target group of users; and
recalculating the usage factor for at least one user group.

8. The computer readable medium of claim 7, further comprising:
determining whether at least one of the one or more recalculated usage factors has exceeded at least one of the corresponding one or more total reserved storage space portions and met one ore more of the criteria for redistribution;
redistributing the reserved storage space for one or more user groups each with usage factors exceeding the corresponding one or more total reserved storage space portions.

9. The computer readable medium of claim 8, wherein redistributing the reserved storage space further comprises increasing the prefix string length by one or more characters and redistributing a first user group into two or more new user groups, wherein each of the two or more new user groups is a subset of the first user group, or creating a new locator.

10. The computer readable medium of claim 9, wherein a given storage server stores at least all users with usernames beginning with a given prefix string.
